(19) United States
(12) Patent Application Publication
(10) Pub. No.: US 2005/0045047 A1
(43) Pub. Date: Mar. 3, 2005

(54) Apparatus and methods for thawing frozen items

(76) Inventor: Melbourne H. Sann, Rome, NY (US)

Correspondence Address: WOOD, HERRON & EVANS, LLP, 2700 CAREW TOWER, 441 VINE STREET, CINCINNATI, OH, 45202, US

(21) Appl. No.: 10/653,446

(22) Filed: Sep. 2, 2003

(51) Int. Cl. A23L 3/36

(52) U.S. Cl. 99/483

(57) ABSTRACT

Apparatus and methods for thawing frozen items, such as frozen food, with water and air convection includes one or more compartments each equipped with a perforated thawing basket, a showerhead delivering a shower of temperature-controlled water onto frozen food in the perforated thawing basket, one or more fans configured to deliver a convective airflow over the frozen food, and a water wheel powered by water draining from the frozen food that is drivingly coupled with each fan. The compartments are hygienically sealed from one another so that water drained from each compartment does not cross-contaminate frozen food being thawed in other compartments.

### FIELD OF THE INVENTION

This Invention relates to apparatus and methods for thawing frozen items and, in particular relates to apparatus and methods for thawing frozen items with temperature-regulated water and air convection.

### BACKGROUND OF THE INVENTION

In commercial kitchens, professional chefs may prepare dozens of different dishes each day that require a number of ingredients in their recipes. To prepare so many different dishes, restaurants must keep large supplies of food on hand; not only fresh foods, but also frozen foods that must be thawed before a chef may prepare a meal. While demand for certain meals may remain fairly regular and the need for ingredients may be anticipated, at times when restaurants run specials on certain dishes, when business fluctuates, etc., demand for dishes and their ingredients becomes uncertain. It is this uncertainty of demand that requires restaurants to keep a great deal of their food frozen and ready to be thawed for an appetite not yet sated.

Conventional food thawers are not optimally suited for thawing food in contemporary professional kitchens in which a chef and kitchen staff need to satisfy demand for meals listed on a restaurant's menu in a timely manner, whether or not the ingredients needed for those dishes is fresh or, as so often is the case, frozen. The contemporary professional kitchen must comply with local or state rules and regulations to ensure that when frozen food is thawed, the thawing process is sanitary and, resultantly, preserves customer health safety.

Generally, restaurants are not allowed to simply immerse frozen food in a water bath for thawing, regardless of whether the water bath is either agitated or filtered and recycled. Contemporary professional kitchens are also prohibited from placing frozen food directly on a food preparation surface, or even a dedicated thawing surface, to allow the food to thaw at the kitchen's ambient temperature. These thawing practices are generally banned from professional kitchens because they present potential health risks to the restaurant's customers, e.g., they are likely to promote bacterial growth.

Certain conventional thawing devices are powered electrically to operate fans, heating elements, or steam generators. Other conventional thawing devices are used to thaw already prepared foods or foods in frozen containers, but lack the ability to thaw different types of raw foods simultaneously. Therefore, such conventional thawing devices pose a greater likelihood of cross-contamination and foreign substance contamination.

Three procedures are generally recognized as being acceptable for thawing food in a professional kitchen. First, food may be removed from a freezer and placed in a refrigerator to thaw. This procedure is rather slow due to the relatively low refrigerator temperature and does not allow a kitchen to meet a sudden demand for a certain dish that requires ingredients still in the freezer. In fact, it generally takes several hours for frozen food to be adequately thawed when using this procedure.

In a second generally recognized procedure, frozen food may be placed in a microwave oven and defrosted. Although this procedure is significantly quicker than thawing food in a refrigerator, thawing food in a microwave oven has drawbacks. Because raising the temperature of food very quickly from its frozen state promotes bacterial growth, microwaved food must then be cooked immediately. Microwaved food also often results in the deterioration of the food's quality, e.g., dehydration, “hot spots,” and inadvertent “cooking” of portions of the food. In addition, purchasing and/or dedicating a microwave oven for food thawing can be expensive if, for example, a restaurant microwave oven under heavy usage breaks down and needs repair. Additionally, the inconvenience of dedicating a microwave oven for thawing food is often impractical. In addition, microwaved food cannot be refrozen and must be either prepared and served or discarded after thawing.

Finally, a professional kitchen may thaw frozen food by placing the food in a sink and running water over the food, all the while allowing the water to drain away from the food. This procedure requires a stream of water at a temperature suitable to warm the frozen food, typically less than 70° F., provided by a cold tap water. However, the frozen food may thaw too quickly and unevenly, and bacterial growth may be promoted. Moreover, a user must attend to the stream of water, as the food thaws, to ensure uniform thawing. Of course, while the user is attending to the thawing food, other kitchen duties are ignored. To prevent cross-contamination, only a single type of food may be placed in the sink at any time. For example, a single stream of water could not be used to thaw shrimp and chicken simultaneously due to the potential for cross-contamination.

These and other methods that utilize the kitchen sink in conjunction with thawing exclude the sink from being used for its intended purpose. The demand for frozen food to be thawed usually comes during peak business hours when the sinks are filled with solutions to wash, rinse, and/or sanitize and are being used for cleaning pots and pans. In addition to the interruption in sink use, the solutions must be drained, wasting water, time, and solution chemicals. The sink must also be sanitized before and after thawing if the frozen food being thawed comes in contact with sink surfaces, thus preventing cross-contamination and bacterial growth.

It would be desirable, therefore, to provide a thawing device and thawing methods that overcome these and other deficiencies of conventional thawing devices and methods.

### SUMMARY

The invention is directed to a combined water and convection thawer and methods of thawing frozen items, such as frozen food. In one aspect, an apparatus for thawing a frozen item includes an enclosure defining a thawing chamber with an inlet port, an outlet port and a perforated thawing basket disposed inside the thawing chamber. The apparatus further includes a showerhead adapted to discharge a shower of water onto the frozen item held by the perforated thawing basket. The water is at a temperature warmer than a temperature of the frozen item so that thawing occurs. The apparatus further includes an air-moving device positioned in the inlet port and configured to force air, also warmer than the temperature of the frozen item, into the thawing chamber and over the frozen item in the perforated thawing basket for exhaust through the outlet port. The apparatus of the invention is particularly suitable for thawing frozen foods in large commercial, restaurant and institutional use and/or professional kitchens.

In another aspect, a method is provided for thawing frozen item that includes supplying water to a thawing chamber at a first temperature suitable for thawing frozen item to a showerhead suspended over the frozen item and directing water from the showerhead over the frozen item. The method further includes directing a forced flow of convective air at a second temperature suitable for thawing frozen item through the thawing chamber and over the frozen item.

In accordance with the principles of the invention, warmed water is distributed evenly over substantially the entire surface area of the frozen item without a user having to attend to the thawing process. The temperature of the warmed water used to thaw the frozen item is regulated to automatically maintain the selected highest optimum thawing temperature allowed by state and local codes. The warmed water employed to thaw the frozen item is drained away, not recycled, while the frozen item is still quickly and evenly thawed. The drained water may power fans located inside, and outside the thawing chamber. The fans create a horizontal and vertical air flow forcing room temperature air in, around, and out of the thawing chamber, thereby using a convective process to thaw food and assisting the thawing action of the warmed water. The thawer may be powered without electricity, which eliminates the dangers and costs associated with electrical appliances, although the invention is not so limited.

In accordance with the principles of the invention, multiple different frozen items may be safely thawed simultaneously without cross-contamination. In addition, other sources of cross-contamination or foreign contamination, such as from kitchen sinks, are eliminated, as the thawing device is self-contained. The thawing water is continuously drained from the thawing chamber so that the frozen item undergoing thawing is never immersed in liquid but rather is exposed to a flowing stream. Temperatures of 70° F. or less, which comport with health department standards for food thawing, are utilized thereby decreasing bacterial growth within the frozen items which are being thawed.

In accordance with one aspect of the invention, a thawing basket for use in the thawer elevates the frozen item above the bottom of a holding basket, which allows the warmed water and the convective air produced by the fans to freely circulate over the entire surface of the food being thawed. In another aspect of the invention, water dripped from the thawing basket may be channeled to power connected vertical fans hanging from the basket bottom, which forces room temperature air in a vertical direction toward the bottom of the basket and upward through the basket interior.

These and other objects and advantages of this invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a front view of a food thawer in accordance with the principles of the invention;

FIG. 2 is a partial cross-section view of the food thawer of FIG. 1;

FIGS. 3 and 4 are side views of the food thawer of FIG. 1;

FIG. 5 is a cross-section view of the food thawer of FIG. 1;

FIG. 6 is an end view of the thawing basket and the air-moving device of FIG. 1; and

FIG. 7 is a side view of a thawing basket and the air-moving device of FIG. 6.

### DETAILED DESCRIPTION OF THE INVENTION

The invention is directed to a convective food thawer primarily for commercial thawing applications in restaurants, institutions, schools, hospitals, and the like. The food thawer can be used for thawing vegetables, shellfish, chicken, meats, and other frozen foods. The convective food thawer provides a fast, efficient and economical means for thawing large quantities of food. Moreover, the food thawer of this invention maintains the flavor, freshness, and returns the frozen food to its pre-frozen state. Importantly, the food is thawed in an even and consistent manner using only temperature-regulated tap water and room temperature air.

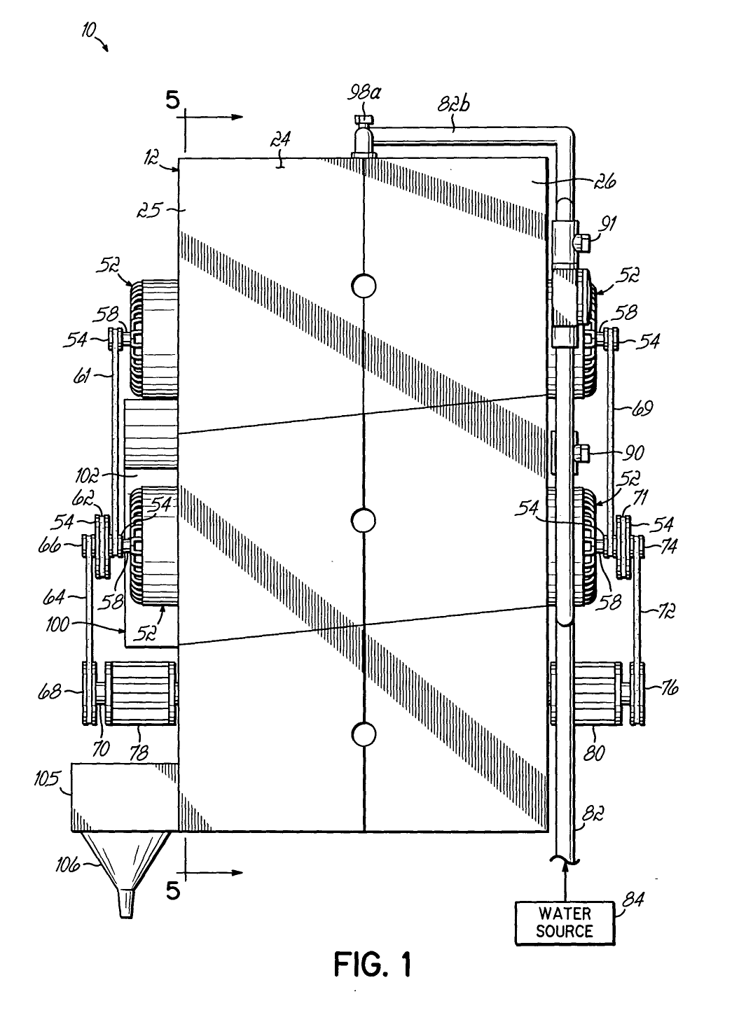

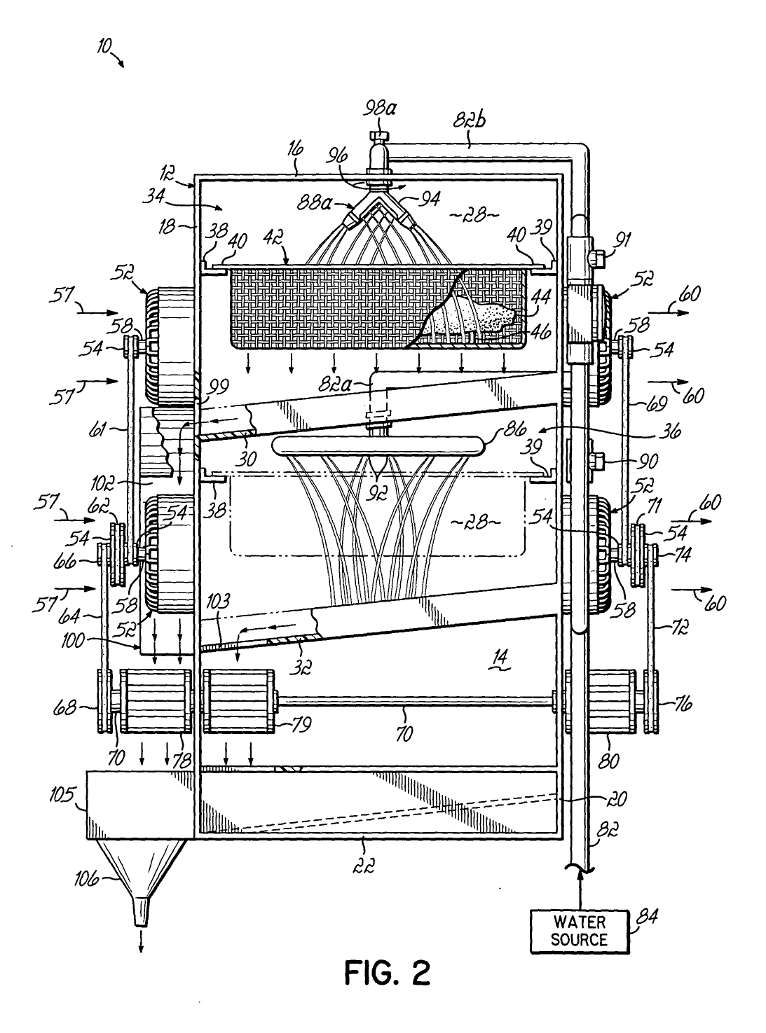

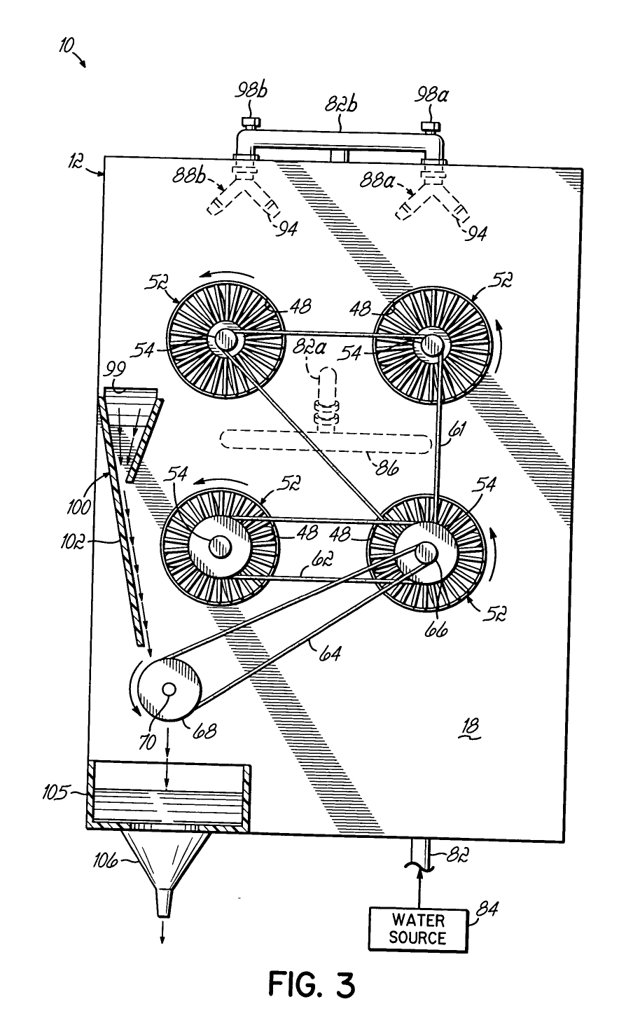

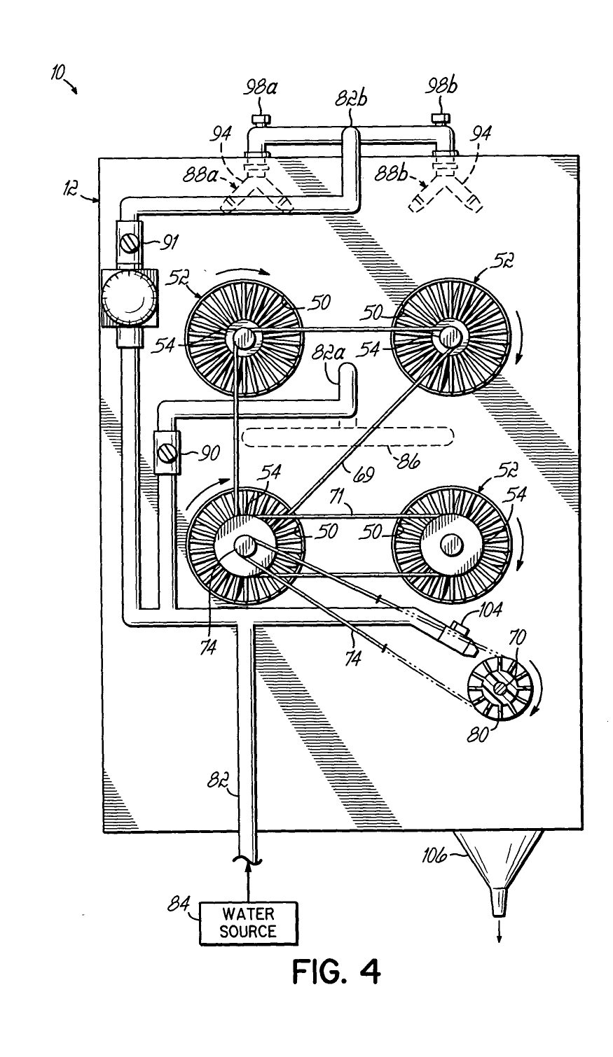

With reference to FIGS. 1-5, a food thawer 10 in accordance with the principles of the invention includes a cabinet or enclosure 12 having a rear wall 14, a top wall 16, a pair of spaced side walls 18, 20, a bottom wall 22, and a front wall 24 including opposed hinged doors 25, 26 that provide access to a thawing chamber 28 defined by the space enclosed by the walls 14,16, 18, 20, 22, and 24. The enclosure 12 may be freestanding, as supported by legs for elevation above ground level, or may be attached to a support structure (not shown), such as a structural wall of a building. Typically, the enclosure 12 is formed of a plastic resin, although the invention is not so limited. In an alternative embodiment, the doors 25, 26 may be replaced by a single guillotine-type door that may be raised and lowered between open and closed positions to provide access to the thawing chamber 28. The dimensions of the thawing chamber 28 may be adjusted to correlate with a required thawing capacity.

The thawing chamber 28 is partitioned by inclined dividing walls 30, 32 into two distinct compartments or tiers 34, 36 that are sealed from one another. Each of the dividing walls 30, 32 may have a sealed engagement about the corresponding peripheral with rear wall 14, side walls 18, 20, and front wall 24, or may be of unitary construction therewith. The number of tiers 34, 36 and dividing walls 30, 32 may be adjusted for varying the configuration of the thawing chamber 28. Provided in each of the tiers 34, 36 is a pair of rails 38, 39 in which one rail 38 is mounted to side wall 18 and the other rail 39 is mounted to the opposite side wall 20. The rails 38, 39 are configured to support one of a pair of support flanges 40 provided along the opposed side edges of a thawing basket 42, typically formed from an open wire mesh, into which a frozen food 44 is placed. A thawing basket 42 is provided in each of the tiers 34, 36. Thawing baskets 42 are removable from the thawing chamber 28 by opening the doors 25, 26 and sliding each thawing basket 42 outwardly along the corresponding set of rails 38, 39. The invention contemplates that an additional pair of rails (not shown but similar to rails 38, 39) may be provided between rail 38 and rail 39 in either of the tiers 34, 36 for accommodating more than one individual thawing basket (not shown) of a reduced size for use in thawing smaller masses of frozen food 44. As the thawing baskets 42 are removable to distance the frozen food 44 therein from the rest of the enclosure 12, the food thawer 10 may be cleaned between thawing procedures simply by cleaning the thawing baskets 42 without necessarily cleaning interior surfaces exposed to the thawing water.

With continued reference to FIGS. 1-5, the open mesh framework of each thawing basket 42 permits efficient drainage of the thawing water sprayed on the frozen food 44. Generally, the frozen food 44 is at a temperature that is below the freezing point of water when placed into the thawing basket 42 and positioned in the thawing chamber 28. The frozen food 44 may be elevated above the wire mesh base of the thawing basket 42 by a plurality of vertically-projecting standoffs 46. This allows the thawing water and the flow of convective air to circulate freely over the entire surface area of the frozen food 44. Moreover, if the frozen food 44 is formed from an agglomerated mass of discrete portions, individual portions that break away from the agglomerated mass are captured in the space beneath the frozen food 44 provided by the standoffs 46. As the food being thawed incrementally breaks away from the agglomerated mass, the standoffs 46 allow more of a surface area of the food being thawed to be exposed to the thawing water and convective air, thereby decreasing the thawing time.

A plurality of, for example, four airflow inlet ports 48 are formed in side wall 18 and, similarly, a plurality of, for example, four airflow outlet ports 50 are formed in the opposite side wall 20. Two of the airflow inlet ports 48 and two of the airflow outlet ports 50 provide paths for cross-flow of convective air into each of the tiers 34, 36. Airflow inlet ports 48 are positioned directly on one side of the thawing basket 42 and airflow outlet ports 50 are positioned directly on an opposite side of the thawing basket 42, thereby forcing a flow of convective air through the thawing basket 42.

With continued reference to FIGS. 1-5, installed in each of the airflow inlet and outlet ports 48, 50 is one of a plurality of fans 52, which are generally identical, each having a pulley 54 and a plurality of fan blades 56 projecting radially outward from a spindle 58 coupled with the pulley 54. Fans 52 in the inlet ports 48 are oriented and driven such that fan rotation causes air to be forced from the environment surrounding the enclosure 12 into the thawing chamber 28, as generally indicated by arrows 57. Fans 52 in the outlet ports 50 are oriented and driven such that fan rotation causes air to be forced out of the thawing chamber 28 into the environment surrounding the enclosure 12, as generally indicated by arrows 60. As a result, the fans 52 in inlet ports 48 and the fans 52 in outlet ports 50 develop a cross-flow of convective air across the frozen food 44 in the thawing basket 42 when operating.

Preferably, each of the airflow inlet ports 48 is generally coaxial with one of the airflow outlet ports 50 in a direct line-of-sight arrangement, although the invention is not so limited. Coaxial alignment of the fans 52 affords the maximum convective airflow in each of the tiers 34, 36. The invention contemplates that the fans 52 in outlet ports 50 may be replaced by louvers or grills (not shown) arranged for establishing a cross-flow of air flow, while preventing the escape of thawing water splashed from the frozen food 44 out of the food thawer 10. Fans 52 may be positioned on an exterior side of the ports 48, 50 as shown in FIGS. 1-5, may be positioned on an interior side of the ports 48, 50, or may be positioned at an intermediate location.

With continued reference to FIGS. 1-5, convective air is continuously drawn by fans 52 located in inlet ports 48 into the thawing chamber 28 at room temperature, which in a commercial kitchen is generally in the range of about 70° F. to about 90° F., when the doors 25, 26 are shut and the fans 52 are powered. The room temperature convective air is forced across the exterior surface of the frozen food 44 held by the thawing basket 42, which is at a lower temperature than the convective air. Heat is transferred from the convective air to the frozen food 44, which cools the convective air and warms the frozen food 44. The cooled convective air is exhausted from the thawing chamber 28 through airflow outlet ports 50, which operates to cool the kitchen environment.

The pulleys 54 on the fans 52 coupled with inlet ports 48 are coupled together by flexible drive belts 61, 62 so that all pulleys 54 are driven by a common power source, as explained below. A drive belt 64 couples a second pulley 66 on one fan 52 from among the fans 52 on side wall 18 with a pulley 68 attached to one end of a drive shaft 70 extending between the side walls 18, 20 and rotatable. Similarly, the pulleys 54 on the fans 52 coupled with outlet ports 50 are coupled together by flexible drive belts 69, 71 so that all pulleys 54 are driven by a common power source, as explained below. A drive belt 72 couples a second pulley 74 on one fan 52 from among the fans on side wall 20 with a pulley 76 attached to an opposite end of the drive shaft 70.

With continued reference to FIGS. 1-5, one end of the drive shaft 70 extends outwardly through side wall 18 and carries a water wheel 78 that may be impinged by drained water from tier 34. Positioned in an open space inside enclosure 12 between bottom wall 22 and dividing wall 32 is a water wheel 79 that may be impinged by drained water from tier 36. An opposite end of the drive shaft 70 extends outwardly through side wall 20 and carries another water wheel 80 that may be impinged by a portion of the water provided from a regulated-temperature water source 84.

A thawing water conduit 82 couples the regulated-temperature water source 84 operative to supply thawing water at a constant temperature, typically about 70° F. or less to comport with safety rules but, in any event, warmer than the frozen food 44 being thawed, to the food thawer 10. The water source 84 combines hot tap water and cool tap water to supply a continuous stream of thawing water fixed at the constant water temperature.

The water conduit 82 includes a branch 88a coupled with a showerhead 86 in tier 36 and another independent branch 82b coupled with a pair of showerheads 88a,b in tier 34. Flow to branch 88a may be discontinued by a shut-off valve 90 positioned in the water conduit 82 and, similarly, flow to branch 82b may be discontinued by another shut-off valve 91 positioned in the water conduit 82. As a result, the tiers 34, 36 may be used individually or collectively. Regardless, the presence of the dividing walls 30, 32 eliminates cross-contamination between frozen foods 44 being thawing in different tiers 34, 36.

With continued reference to FIGS. 1-5, showerhead 86 is suspended generally above thawing basket 42 in tier 34 and has a plurality of orifices 92 facing downwardly toward the bottom wall 22. The orifices 92 are each oriented about the circumference of the showerhead 86 such that the shower of water is emitted from orifices 92 as a plurality of streams that rotate the showerhead 86 and bath substantially the entire cross-sectional area of the thawing basket 42, when viewed vertically in a direction extending from the top wall 16 to the bottom wall 22. As a result, thawing water is symmetrically distributed over a surface area of frozen food 44 confronting the showerhead 86 and thawing water is distributed over substantially all regions within the thawing basket 42.

Each of the showerheads 88a,b is suspended generally above thawing basket 42 in tier 36 and includes a pair of nozzles 94 from which multiple streams of water are emitted. Each of the showerheads 88a,b rotates in a direction generally indicated by arrow 96 when water is exhausted from the nozzles 94, as a reactionary force to the exhausted streams of water. As a result, the individual streams of water are moved about the thawing basket 42 to spray different regions of the thawing basket 42 and frozen food 44 held therein. A pair of shut-off valves 98a,b are provided of which valve 98a is operative for selectively blocking water flow to showerhead 88a and valve 98b is operative for selectively blocking water flow to showerhead 88b. The shut-off valves 98a,b may be used in conjunction with reduced-size thawing baskets 42 so that only a portion of tier 36 may be used to thaw frozen food 44, if desired, while conserving water.

The flow of thawing water over the frozen food 44 is continuous, which implies that the water bathing the frozen food 44 at any instant in time is at or near the controlled temperature. This contrasts with a conventional situation in which frozen food is immersed in a static bath in a kitchen sink during thawing. The frozen food continuously removes heat from the thawing water, which gradually reduces the temperature of the thawing water and thereby reduces the thawing efficiency. Therefore, the continuous flow of thawing water in accordance with the principles of the invention significantly improves the thawing efficiency.

The invention contemplates that multiple different showerheads and fan designs are within the spirit and scope of the invention specifically for directing and enhancing the water distribution and convective airflow.

With continued reference to FIGS. 1-5, thawing water originating from showerheads 88a,b is collected by the inclined dividing wall 30 and is drained by gravity from tier 34 through a drain opening 99 in side wall 18 into a substantially vertical spillway 100 located outside and adjacent to the side wall 18. An extended guide surface 102 of spillway 100 directs the drained water from tier 34 onto a downward turning side of water wheel 78. Similarly, thawing water originating from showerhead 86 is collected by the inclined dividing wall 32 and is drained by gravity from tier 36 through a drain opening 103 in dividing wall 32. The falling drain water is directed from tier 36, independent of water drained from tier 34, onto a downward turning side of water wheel 79. A bypass valve 104 may be provided in the water conduit 82 that is capable of switching a portion of the water flow from the water source 84 for powering the fans 52. Specifically, the bypass valve 104 diverts a portion of the water stream arriving from the water source 84 onto a downwardly turning side of the water wheel 80. The action of the drain water striking on the water wheels 78, 79 and, optionally, the source water flowing over water wheel 80 provides the power for rotating the fans 52 to provide the convective air flow through each tier 34, 36 of the thawing chamber 28. As a result, the food thawer 10 may be operated without electricity to provide the convective air or to distribute the thawing water over the frozen food 44. The only electricity that may be required for operation of the food thawer 10 is to heat the hot tap water used by the water source 84. In an alternative embodiment, the invention contemplates that the fans 52 may be electrically powered. The drained thawing water, after striking the water wheels 78, 79, is diverted by a drain tray 105 and a funnel shaped outlet 106 for disposal in a sanitary drain.

In use and with reference to FIGS. 1-5, the doors 25, 26 are opened, one of the thawing baskets 42 is withdrawn from the thawing chamber 28, a quantity of frozen food 44 is placed in the thawing basket 42, and the thawing basket 42 is returned to the thawing chamber 28. After the doors 25, 26 are shut to isolate the thawing chamber 28, a flow of water at the desired regulated temperature is initiated through the water conduit 82 and is directed to the appropriate tier, for example tier 34, in which the thawing basket 42 and frozen food 44 are disposed. The thawing water is discharged from the showerhead 86, with the rate that the water is exhausted defined by flow restrictions in the showerhead 86. The thawing water showers over at least the entire top surface cross-sectional area of the thawing basket 42 and, thus, the frozen food 44 to be thawed.

After the flow of thawing water is initiated, water draining from the tier 34 is channeled by the corresponding dividing wall 32 to water wheel 79, without cross-contaminating the other tier 36. The force of the draining water pouring down onto the water wheel 79 turns the water wheel 79 thereby powering the fans 52. In the alternative, the bypass valve 104 may be used to direct a portion of the incoming thawing water to another water wheel 80 for powering the fans 52. The rotation of the water wheel 79 drives the fans 52, which creates a cross-flow of convective air through the thawing chamber 28. The air cross-flow permeates the wire mesh of each perforated thawing basket 42 and flows across the surface of the frozen food 44, which assists or supplements the thawing action of temperature-regulated water from showerhead 86. It is appreciated that a similar description of the operation of the food thawer 10 applied to frozen food 44 placed in thawing basket 42 of tier 36 and to additional tiers (not shown) that may be added to the configuration of food thawer 10.

The food thawer of the invention may be operated in an unattended manner. Specifically, a user may then set a timer (not shown) either associated with the temperature-regulated water source or on the food thawer and leave the food thawer and frozen food unattended during that timed period because the showerheads and fans are free from the need for attendance and manipulation by the user.

In accordance with the principles of the invention, frozen food is thawed at an accelerated rate due to the combination of temperature-regulated water that is showered over the frozen food and the cross-flow of convective air. It has been observed that a five (5) pound block of frozen shrimp may be thawed in the food thawer in about ten (10) minutes or less, which is over an order of magnitude faster than an equivalent mass of frozen shrimp thawed by submersion in water in a kitchen sink. Another benefit of the invention is that the thawing baskets may be removed from the food thawer and individually cleaned. As a result, kitchen sinks do not have to be cleaned and sterilized to thaw food.

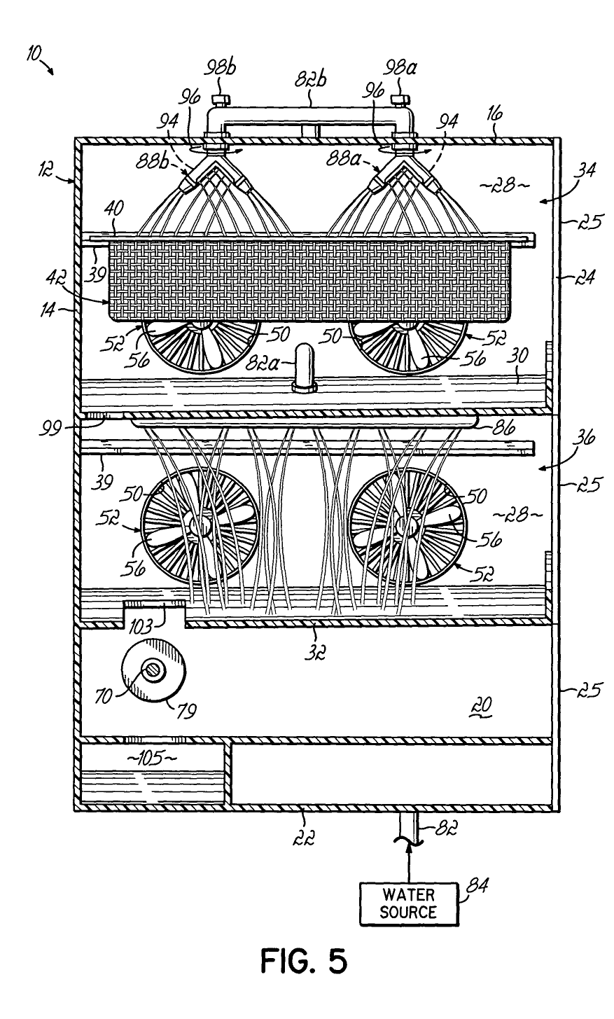

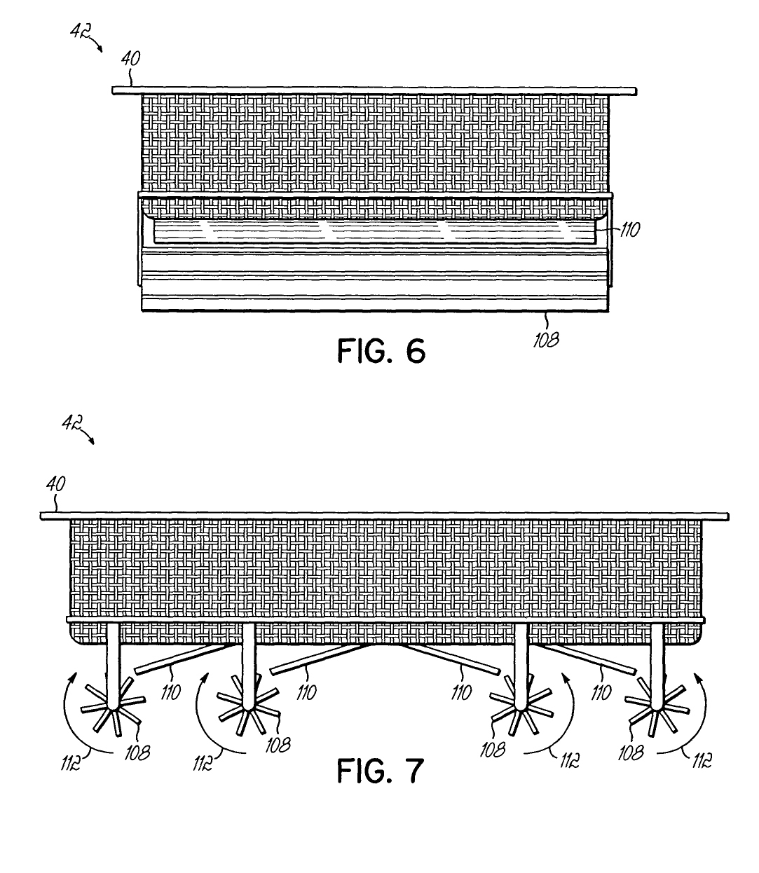

With reference to FIGS. 6 and 7 in which like reference numerals refer to like features and in accordance with an alternative embodiment of the invention, the thawing basket 42 may be provided with a plurality rotatable paddle wheels or fans 108 and a corresponding plurality of drip plates 110. The fans 108 are removably-fastened to an underside of the thawing basket 42. Each of the drip plates 110 is inclined downwardly toward the bottom wall 22 for channeling water draining from the thawing basket 42 by gravity to a downwardly turning side of a corresponding one of the fans 108. The force of the draining water rotates the fans 108, which causes an upward airflow directed toward the bottom of the thawing basket 42 and a horizontal airflow, generally indicated by reference numeral 112. The upward airflow cooperates with the flow of convective air from fans 52 and the flow of thawing water from the showerheads 86, 88a,b to aid in thawing the frozen food 44.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. For example, the food thawer of the invention may be used to thaw other types of frozen items, such as frozen blood products or human organs. The invention in its broader aspects is therefore not limited to the specific details, representative apparatus and methods, and illustrative examples shown and described. Accordingly, departures may be made from such details without departing from the spirit or scope of applicant's general inventive concept. The scope of the invention itself should only be defined by the appended claims.

1. An apparatus for thawing a frozen item, comprising:
an enclosure defining a thawing chamber with an inlet port and an outlet port;
a perforated thawing basket disposed inside the thawing chamber and configured to hold the frozen item;
a showerhead adapted to discharge a shower of water warmer than a temperature of the frozen item onto the frozen item held by the perforated thawing basket; and
a first air-moving device positioned in the inlet port and configured to force air warmer than the temperature of the frozen item into the thawing chamber and over the frozen item in the thawing basket for exhaust through the outlet port.

2. The apparatus of claim 1 further comprising:
a rotatable water wheel drivingly coupled with the first air-moving device; and
a dividing wall collecting water discharged from the showerhead as drain water and directing the drain water to power the water wheel.

3. The apparatus of claim 2 further comprising:
a second air-moving device positioned in the outlet port and configured to force air out of the thawing chamber through the outlet port.

4. The apparatus of claim 3 wherein the second air-moving device is coupled with the water wheel for driven rotation.

5. The apparatus of claim 1 further comprising:
a rotatable water wheel drivingly coupled with the first air-moving device;
a source of a water flow coupled with the showerhead; and
a diverting valve capable of directing a portion of the water flow for powering the rotatable water wheel.

6. The apparatus of claim 1 further comprising:
a dividing wall partitioning the thawing chamber into first and second compartments, the perforated thawing basket being located inside one of the first and second compartments.

7. The apparatus of claim 1 further comprising:
a second air-moving device positioned in the outlet port and configured to force air out of the thawing chamber through the outlet port.

8. The apparatus of claim 1 further comprising:
a drip plate positioned beneath the thawing basket; and
a second air-moving device mounted to the thawing basket such that water draining from the thawing basket rotates the second air-moving device to produce an airflow directed toward the thawing basket.

9. A method of thawing frozen item comprising:
supplying water to a thawing chamber at a first temperature suitable for thawing frozen item to a showerhead suspended over the frozen item;
directing water from the showerhead over the frozen item; and
directing a forced flow of convective air at a second temperature suitable for thawing frozen item through the thawing chamber and over the frozen item.

10. The method of claim 9 further comprising:
draining water from the frozen item; and
channeling the draining water to power one or more fans providing the forced flow of convective air into the thawing chamber.

11. The method of claim 9 further comprising:
diverting water supplied to the showerhead to power at least one fan providing the forced flow of convective air.

12. The method of claim 9 further comprising:
capturing water draining from the frozen item;
exhausting the forced flow of convective air from the thawing chamber; and
channeling draining water to power at least one fan providing the forced flow of convective air from the thawing chamber.

13. The method of claim 9 further comprising:
diverting water supplied to the showerhead to power at least one fan providing a forced flow of convective air out of the thawing chamber.

14. The method of claim 9 wherein directing the forced flow of convective air and directing water from the showerhead are performed simultaneously.

15. The method of claim 9 wherein said first temperature is equal to said second temperature.
